(19) United States
(12) Patent Application Publication
(10) Pub. No.: US 2014/0367367 A1
(43) Pub. Date: Dec. 18, 2014

(54) ADDITIVE LAYER MANUFACTURING METHOD

(71) Applicant: ROLLS-ROYCE PLC, London (GB)

(72) Inventors: Scott David WOOD, Nottingham (GB); Michael Lewis BLACKMORE, Sheffield (GB); Iain TODD, Sheffield (GB)

(73) Assignee: ROLLS-ROYCE PLC, London (GB)

(21) Appl. No.: 14/290,178

(22) Filed: May 29, 2014

(30) Foreign Application Priority Data
Jun. 17, 2013 (GB) 1310762.8

(51) Int. Cl. B23K 15/00

(52) U.S. Cl. CPC B23K 15/0086; B23K 15/0006
USPC 219/76.12

(57) ABSTRACT

An additive layer manufacturing method includes the steps of: a) laying down powder layer on powder bed, and b) focussing energy on an area of powder layer to fuse area of powder layer and thereby form a cross-section of the product; wherein steps a) and b) are repeated to form successive cross-sections of product, and wherein at least one of said steps b) involves focussing energy on an area of respective powder layer which is unsupported by a previously formed cross-section of product to thereby form a downwardly facing surface of product. Method is at least some of said successive steps b) involve focussing energy on a support area of respective powder layer, to fuse support area and thereby form successive cross-sections of a support pin within powder bed, support pin extending outwardly from downwardly facing surface of product when it is formed, so as to support downwardly facing surface.

### CROSS-REFERENCE TO RELATED APPLICATIONS

This application is based upon and claims the benefit of priority from British Patent Application Number 1310762.8 filed 17 Jun. 2013, the entire contents of which are incorporated by reference.

### BACKGROUND OF THE INVENTION

1. Field of the Disclosure

The present invention relates to an additive layer manufacturing (ALM) method, and more particularly relates to an ALM for the production of a three-dimensional product via successive fusion of parts of a powder bed, said parts corresponding to successive cross-sections of the product.

2. Description of the Related Art

Additive layer manufacturing has become more widely used over recent years in order to produce three-dimensional products. Electron Beam Melting (EBM) is a particular type of ALM technique which is used to form fully dense metal products (such as component parts for gas turbine engines in the aerospace industry). The technique involves using an electron beam in a high vacuum to melt metal powder in successive layers within a powder bed. Metal products manufactured by EBM are fully dense, void-free, and extremely strong.

FIG. 1 illustrates a known configuration of apparatus 1 which is used in an EBM method to produce a three-dimensional metal product 2 from metal powder 3. The apparatus comprises an adjustable height work platform 4 upon which the product 2 is to be built, a powder dispenser 5 such as a hopper, a rake 6 or other arrangement operable to lay down a thin layer of the powder 3 on the work platform 4 to form the powder bed 7, and an electron beam column 8 for directing and focussing an electron beam 9 downwardly on the powder bed 7 in order to melt parts of uppermost layer of the powder bed 7. The entire apparatus is housed within a vacuum housing and the operative parts are computer controlled.

During operation, the electron beam column 8 is energised under the control of the computer to focus the electron beam onto the powder bed 7 and to scan the beam across the powder bed to melt a predetermined area of the top layer of the powder bed 7 and thereby form a cross-section of the three-dimensional product 2.

The three-dimensional product 2 is built up by the successive laying down of powder layers on the powder bed 7 and melting of the powder in predetermined areas of the layers to form successive cross-sections of the product 2. During a work cycle the work platform 4 is lowered successively relative to the electron beam column 8 after each added layer of powder has been melted, ready for the next layer to be laid down on top. This means that the work platform 4 starts in an initial position which is higher than the position illustrated in FIG. 1, and in which position a first layer of powder of necessary thickness is laid down on the work platform 4 by the rake 6. In order to prevent damage to the work platform 4 by the electron beam 9, the first layer of powder is typically made thicker than the other applied layers, thereby preventing melt-through by the electron beam 9. This is why the product 2 appears spaced above the work platform 4 within the powder bed 7 in FIG. 1. The work platform 4 is then successively lowered for the laying down of a new powder layer for the formation of a new cross-section of the product 2.

When the electron beam 9 impinges on the top layer of powder within the powder bed 7, the kinetic energy of the electrons is transformed into heat which melts the powder to form the respective cross-section of the product 2. The layer previously scanned usually serves as a rigid support for the next layer above. However, when the product has a shape which defines an overhanging or downwardly facing surface 10 such as is illustrated in FIG. 1, then the top layer of powder being scanned by the beam 9 will not have a rigid support beneath it. In this context, a downwardly facing surface 10 is defined as one whose orientation enables its projection onto a horizontal two-dimensional plane below it, as illustrated schematically in FIG. 2.

If no support is provided beneath downwardly facing surfaces 10 of the product 2 as it is formed, then localised overheating can occur during melting of the powder by the beam 9 which can result in poor surface finish to the product. Also, distortion of the product can occur and so it has been proposed previously to provide some means of mechanically fixing the product in place relative to a metallic substrate or base plate 11 on which the product is formed.

Previously proposed support structures 12 designed to avoid the problems mentioned above in relation to unsupported downwardly facing surfaces generally consist of an array of thin walls that are manufactured at the same time as the product and from the powder via the same EBM technique. These thin walls are created so as to extend between the downwardly facing surface 10 and another solid surface. The other solid surface can either be a base plate 11 on which the product is formed, or a previously formed upwardly facing surface of the product in the case where the downwardly facing surface 10 is formed above such a surface. These structures 12 are typically referred to as ‘wafers’, and are illustrated schematically in FIGS. 3 and 4. The wafers are designed to be removable from the downwardly facing surface 10 by hand or machine tools during a subsequent finishing procedure.

As illustrated most clearly in FIG. 4, the thin-walled structures or wafers 12 may be provided in a lattice configuration as viewed from below the downwardly facing surface 10, which thus defines an array of small spaces 13 between the wafers 12. It is common for powder feedstock to become trapped in these spaces 13 as the wafers are built up during the EBM process, and the trapped powder can then be difficult to remove and separate from the fused powder forming the wafers 12 themselves during the subsequent finishing process. The trapped powder is thus typically discarded rather than being recycled for subsequent use. Powder feedstock used to manufacture component parts of gas turbine engines is typically very expensive, so this wastage increases the overall manufacturing cost.

It has often been found that the wafer supports 12 produced by prior art methods can be difficult to remove from some intricately shaped products during subsequent finishing processes.

The deposition of wafer supports 12 must start on a solid substrate, which as mentioned above can either be an area of the component being manufactured, or an underlying base plate. The surface finish and geometrical tolerance of the component in contact with the wafers is also reduced and the total foot print of the supported component is increased. Both reduce the manufacturing efficiency for the component

Distortion of the downwardly facing surface 10 represents another problem that can arise when utilising wafer supports 12. This distortion typically arises from the formation of concave regions 14 on the supported surface in the area between each wafer support, as illustrated schematically in FIG. 5.

### OBJECTS AND SUMMARY

It is a preferred object of the present invention to provide an improved ALM method for the production of a three-dimensional product.

According to the present invention, there is provided an additive layer manufacturing (ALM) method for the production of a three-dimensional product via successive fusion of parts of a powder bed, said parts corresponding to successive cross-sections of the product, the method comprising the steps of: a) laying down a powder layer on said powder bed, and b) focussing energy on a predetermined area of said powder layer to fuse said area of the powder layer and thereby form a cross-section of the product; wherein steps a) and b) are repeated to form successive cross-sections of the product, and wherein at least one of said steps b) involves focussing said energy on an area of the respective powder layer which is at least partially unsupported by a previously formed cross-section of the product to thereby form a downwardly facing surface of the product, the method being characterised in that at least some of said successive steps b) involve focussing energy on a support area of the respective powder layer which is spaced from the predetermined area of the powder layer, to fuse the support area and thereby form successive cross-sections of a support pin within the powder bed, the support pin extending outwardly from the downwardly facing surface of the product when it is formed, so as to support the downwardly facing surface.

Preferably, at least some of said successive steps in which energy is focussed on a support area of a respective powder layer also involve focussing energy on a said predetermined area of the powder layer to fuse said area of the powder layer and thereby form a cross-section of the product, the support area and the predetermined area being spaced apart.

Said support pin preferably extends generally downwardly from said downwardly facing surface of the product.

Said successive steps in which energy is focussed on a support area of the respective powder layer may involve focussing energy on a plurality of said support areas in spaced relation to one another, to thereby form successive cross-sections of a plurality of said support pins, the support pins being formed in a spaced array within the powder bed.

Preferably, said support pins are parallel to one another. Alternatively, however, the pins may be non-parallel to one another.

In preferred embodiments the or each support pin is approximately cylindrical, and may optionally have a diameter in the range 0.2 mm to 2 mm. It should be noted, however, that the pins can have alternative cross-sectional profiles such as, for example, square or hexagonal.

In some embodiments of the invention the or each said support area is circular, and energy is focussed on successive said support areas of respective powder layers which are in alignment to one another to form successive circular cross-sections of the or each support pin which is thus cylindrical. In such an embodiment, the or each support pin may thus be formed so as to extend vertically within the powder bed.

Alternatively, the or each said support area is approximately elliptical, and energy is focussed on successive said support areas of respective powder layers which are imbricated to form successive elliptical cross-sections of the or each support pin which is thus cylindrical. In such an embodiment, the or each support pin may thus be formed so as to extend non-vertically within the powder bed.

In preferred embodiments of the method, the or each support pin has a free end which is formed within the powder bed.

Preferably, the free end of the or each said support pin is spaced from any other surface of the product, and is also spaced from any base plate used to support the powder bed.

The free end of the or each said support pin may be formed by focussing energy on an initial support area which is supported only by underlying unfused powder in the powder bed, to fuse said initial support area and thereby form the free end.

Preferably, the method involves Electron Beam Melting and is used to manufacture metal products. Accordingly, said powder is preferably metal powder, and said steps of focussing energy on said areas of the powder layers preferably involves the use of an electron beam to melt said areas of the powder layers.

According to another aspect of the present invention, the above-defined method may be used to manufacture a component of a gas turbine engine, and involves the step of removing the or each said support pin from said product to form said component.

### BRIEF DESCRIPTION OF THE DRAWINGS

So that the invention may be more readily understood, and so that further features thereof may be appreciated, embodiments of the invention will now be described by way of example with reference to the accompanying drawings in which:

FIG. 1 (discussed above) is a schematic vertical cross-sectional view showing a generally conventional apparatus suitable for use in an ALM method for the manufacture of a three-dimensional product from powder feedstock;

FIG. 2 (discussed above) is a schematic cross-sectional view showing a product with a downwardly facing surface;

FIG. 3 (discussed above) is a view similar to that of FIG. 2, but which shows the downwardly facing surface supported by prior art wafer supports;

FIG. 4 is a schematic underneath plan view showing the wafer supports of FIG. 3 in more detail;

FIG. 5 is an enlarged cross-sectional view showing distortion of a downwardly facing surface of a product, between the prior art wafer supports;

FIG. 6 is a schematic cross-sectional view showing part of a product having a horizontally extending, downwardly facing surface supported by a plurality of support pins formed via the method of the present invention;

FIG. 7 is a schematic underneath plan view showing the arrangements of support pins in further detail;

FIG. 8 is a schematic cross-sectional view showing a product having downwardly facing surfaces which can be manufactured via the method of the present invention;

FIG. 9 is a schematic illustration showing an initial step of the method of the invention;

FIG. 10 is a view similar to that of FIG. 9, but which shows a subsequent step of the method;

FIG. 11 shows another subsequent step of the method involving the fusion of areas of a layer of powder;

FIG. 12 is a plan view from above, showing the arrangement of the fused areas shown in FIG. 11;

FIG. 13 shows a subsequent step of the method;

FIG. 14 shows yet another subsequent step of the method;

FIG. 15 is a schematic cross-sectional view showing part of a product having an inclined and downwardly facing surface supported by a plurality of support pins which may formed via the method of the present invention.

FIG. 16 is a horizontal cross-sectional view taken along line I-I of FIG. 15.

### DETAILED DESCRIPTION OF THE PREFERRED EMBODIMENTS

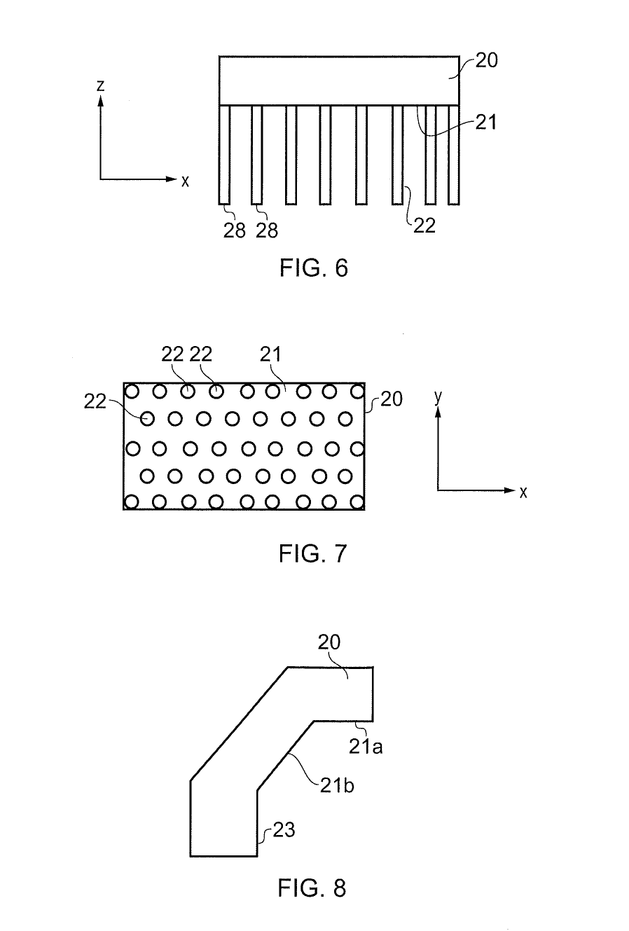

Turning now to consider the drawings in more detail, the method of the present invention will now be described in detail, with particular reference to FIGS. 6 to 16.

The technical effect of the present invention can most easily be understood with regard to FIGS. 6 and 7 which show a product 20 which is manufactured by the method of the invention. The product 20 illustrated in FIGS. 6 and 7 is a metal product and is formed via an ALM method from metal powder.

As illustrated most clearly in FIG. 6, the product has a horizontally oriented lower surface 21 which is downwardly facing. FIG. 6 also shows the downwardly facing surface 21 being supported by a plurality of narrow and elongate support pins 22 which extend downwardly from the downwardly facing surface 21.

FIG. 7 shows the arrangement of the support pins 22 as viewed from below the product 20 and shows the support pins 22 arranged in a generally regular array across the downwardly facing surface 20. The pins 22 are formed via fusion of the same powder feedstock from which the product 20 is formed, and via a similar technique. The pins 22 effectively substitute the wafer support structures 12 of the prior art described above and thus serve to support the downwardly facing surface 21 as the product 20 is built up in a powder bed. The size and configuration of the pins can vary, but it has been found that pins having a circular cross-section and a diameter of approximately 0.8 mm provide particular advantages over the prior art wafer structures 12.

A supporting structure for the downwardly facing surface 21 which is formed from support pins 22 of the type illustrated has been found to be quicker and less expensive to produce than the prior art wafer structures 12, which makes their use very significant in a commercial ALM context.

It has been found that the supporting pins 22 do not trap un-melted powder feedstock between them to the same degree as prior art wafer structures, and they thus permit more efficient recycling of powder. It has also been found that the supporting pins 22 actually use less powder in their manufacture, which further reduces wastage of powder feedstock. The supporting pins 22 can also provide better control and reduction of distortion on the downwardly facing surface 22 and are also more easily removed during subsequent finishing of the product. As will become apparent from the following description of the method, the support pins 22 can be formed so as to have free ends formed within a powder bed, rather than needing to be built up from lower rigid surfaces such as might be defined by other parts of the product, or by a metal base plate inserted within the powder bed.

FIG. 8 illustrates a vertical cross-section through an exemplary product 20 which is used herein to highlight key aspects of the present invention. As will be noted, the product 20 has two downwardly facing surfaces, namely a horizontally oriented surface 21 a similar to the one shown in FIG. 6, and a sloping surface 21 b which is inclined to the vertical in the orientation of the product shown. Additionally, beneath the sloping surface 21b, the product 20 also has a vertically oriented surface 23 which is not downwardly facing.

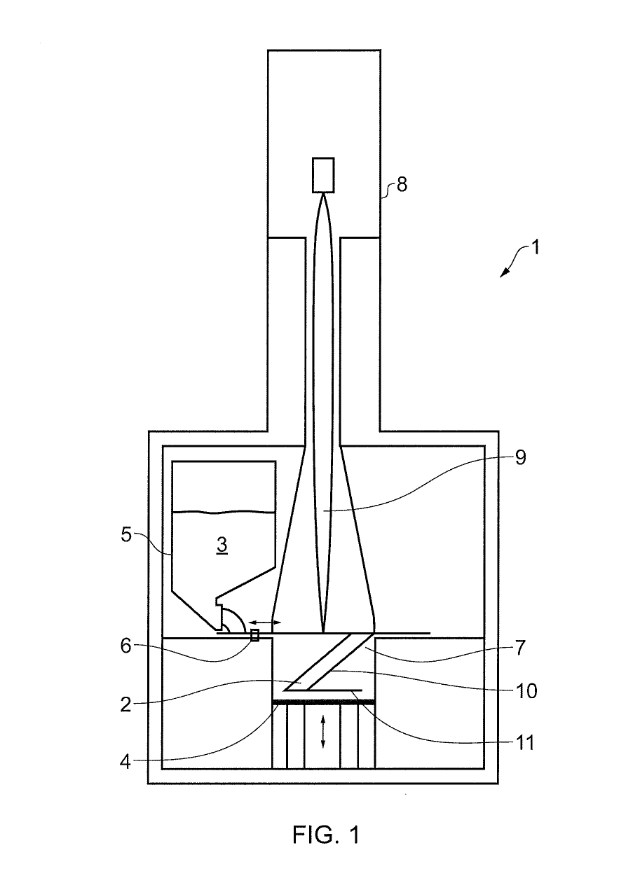

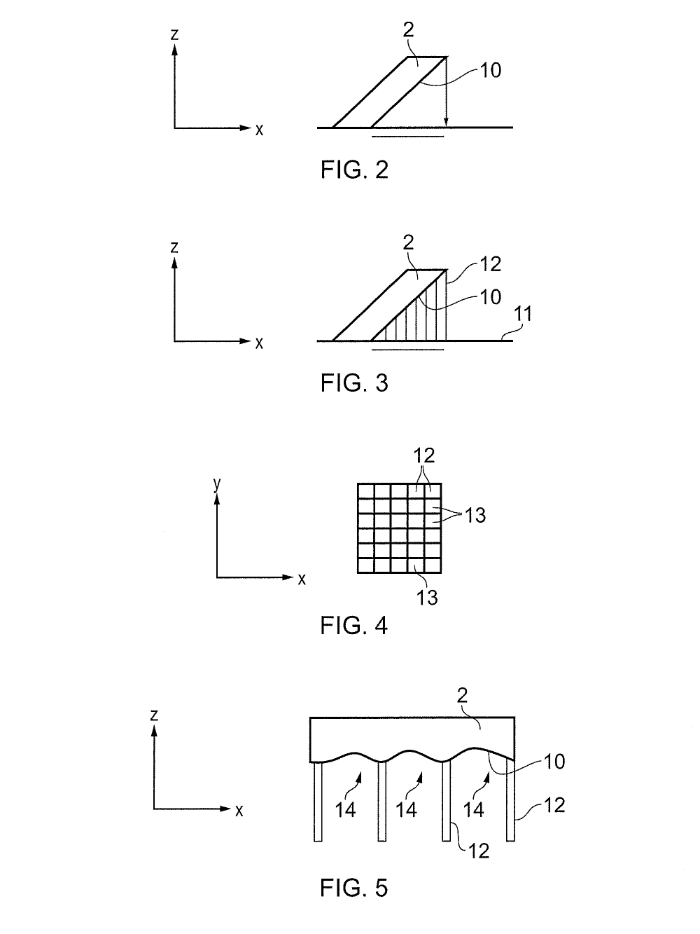

The method of the present invention can be performed using apparatus generally similar to the apparatus shown in FIG. 1. Accordingly, particular reference is made herein to the use of Electron Beam Melting of metal powder feedstock. However, it is to be noted that the invention is not limited to EBM, and could be embodied in alternative ALM techniques in which a three-dimensional product is formed via successive fusion of parts of a powder bed, said parts corresponding to successive cross-sections of the product.

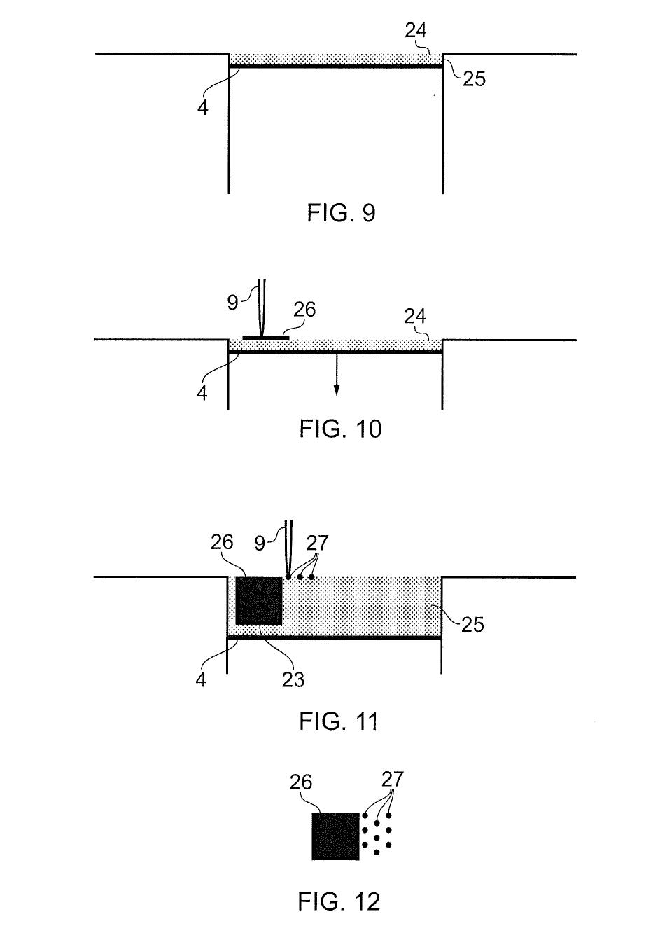

FIG. 9 illustrates an initial step in the method of manufacturing the product, and shows the work platform 4 of an EBM apparatus in an initial raised position. An initial layer 24 of metal powder feedstock is laid on the work table 4 to start a powder bed 25. The powder may be spread into the layer 24 via the rake 6 of the apparatus shown in FIG. 1. In a similar manner to prior art methods, the initial layer 24 of the powder bed 25 can be laid thicker than subsequent layers.

FIG. 10 shows a subsequent step in which an electron beam 9 is focussed on and scanned across a predetermined area 26 of the initial powder layer 24. The beam thus melts the powder in the predetermined area 26, thereby fusing the area 26 and forming an initial cross-section of the product 20. The shape of the cross-section is effectively defined by the shape of the predetermined area 26.

The table 4 is then lowered and another layer of powder is laid on top of the first layer 24, thereby adding to the powder bed 25, whereupon the electron beam 9 is again focussed on and scanned across an identically sized and positioned predetermined area of the top layer, thereby forming the next cross-section of the product, on top of the first cross-section.

The steps of laying down a layer of powder and then focussing/scanning the electron beam over a predetermined area of the layer are repeated to form successive cross-sections of the product 20, thereby gradually building the product from the bottom up. During the initial stages of the method, these steps are repeated to form identical and vertically aligned cross-sections of the product, thereby building up the lower part of the product having the vertical surface 23. It is to be noted that during this stage of the method, the respective predetermined areas 26 of each successive layer of powder are thus all aligned with one another.

FIG. 11 illustrates a stage during the formation of the product at which the lower part of the product 20 and its vertical surface 23 is complete. This drawing therefore shows the final cross-section of the lower part of the product having just been formed by melting a predetermined area 26 of the top layer of powder on the powder bed 25. Before the table 4 is subsequently lowered ready for the next powder layer to be laid on the powder bed 25, the electron beam is refocused, in turn, on a plurality of small spaced apart support areas 27. The support areas are all spaced from the predetermined area of the same layer of powder which is fused to form the cross-section of the lower part of the product 20.

FIG. 12 shows the arrangement of the support areas 27 in plan view. As will be noted, the support areas 27 are substantially circular in shape and arranged in a series of rows which cooperate to define a generally regular array. The support areas 27 most preferably have a diameter of approximately 0.8 mm.

As will be appreciated, focussing the electron beam 9 on each of the support areas 27 melts the powder in those areas, thereby fusing the powder. The fused support areas 27 of the top layer of powder thus form initial cross-sections of respective support pins 22 similar to those illustrated in FIGS. 6 and 7. The initial cross-sections of the support pins 22 which are formed in this way define free ends 28 of the respective support pins 22.

It is to be noted that the free ends 28 of the support pins 22 are thus formed in the top layer of the powder bed 25 (at the stage illustrated in FIG. 11), and are spaced from all other rigid structures such as surfaces of the product 20 being formed and the work table 4. The initial support areas 27 which are fused to define the ends 28 of the support pins are only supported by underlying powder in the powder bed 25.

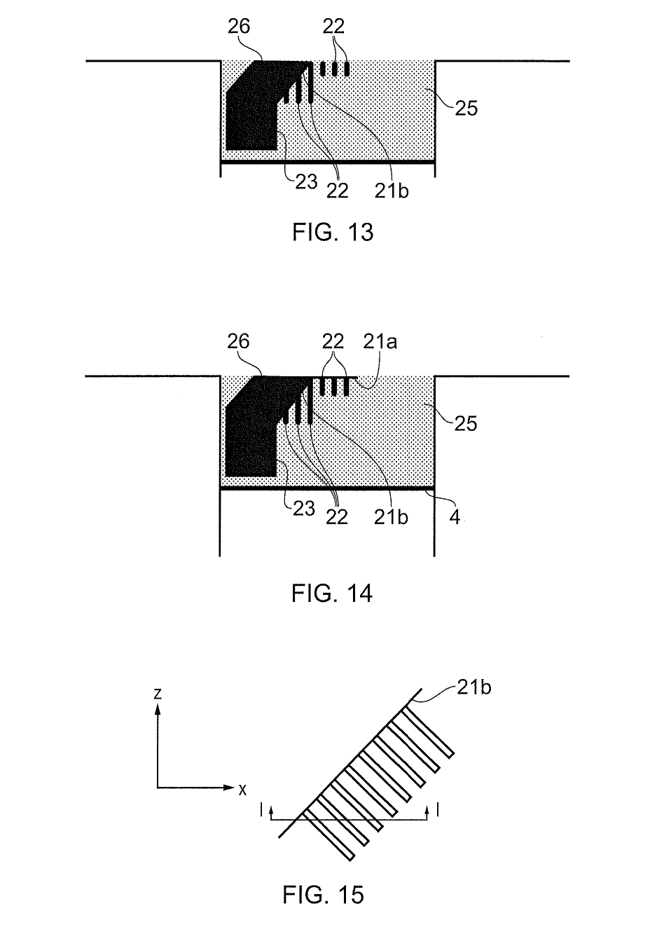

A series of further successive layers of powder then continue to be laid on the powder bed 25. When each layer has been laid, the electron beam 9 is focussed on correspondingly shaped and positioned support areas 27 to melt the powder material in the support areas and thereby steadily build up successive cross-sections of the support pins 22, as shown schematically in FIG. 13. The successive support areas 27 of each powder layer which are melted to form each support pin 22 are thus aligned with one another, such that each support pin 22 is built up vertically.

As will also be evident from FIG. 13, the electron beam 9 also continues to be focussed on respective predetermined areas 26 of the layers to melt the powder material in the predetermined areas and thereby define respective cross-sections of the central region of the product 20. However, the predetermined areas 26 of each layer which are melted during this stage of the procedure differ from one another in the sense that each successive predetermined area 26 is slightly larger than the preceding one such that in each layer a region of the predetermined area 26 is partially unsupported by the previously formed cross-section of the central region of the product 20. The inclined downwardly facing surface 21b is thus built up gradually in this way, layer by layer.

As will also be noted from FIG. 13, each support pin 22 which was shown being started in FIGS. 11 and 12, is eventually completed by its final cross-section being defined by a support area 27 which becomes subsumed by the predetermined area 26 of the respective layer of powder. The support pins 22 thus extend outwardly from the inclined downwardly facing surface 21b, the pins extending vertically downwardly within the powder bed 25 and are parallel to one another.

FIG. 13 also shows a second set of support pins 22 being built up in substantially the same manner as described above; with a series of further support areas 27 of each layer being melted to define successive cross-sections of the support pins 22. The second set of support pins 22, shown as incomplete in FIG. 13, will provide support for the subsequent formed horizontal downwardly facing surface 21 a of the product 20. As will be noted, the second set of support pins 22 are formed by melting respective support areas 27 of powder layers in which the partially unsupported predetermined areas 26 are also melted.

FIG. 14 shows a stage in the production process in which the predetermined area 26 of the top powder layer has a size and shape corresponding to the cross-section of the upper region of the product 20. FIG. 14 thus shows the creation of the first cross-section of the upper region of the product, and hence the horizontal downwardly facing surface 21a of the product. As will be noted, therefore, a very significant proportion of the predetermined area 26 of the upper powder layer is unsupported by the previously formed cross-section of the product 20. However, the downwardly facing surface defined by the top predetermined area 26 is supported by the previously built up support pins 22 beneath the surface 21a, the support pins thus extending downwardly from the surface 21a.

The subsequent cross-sections of the relatively wide upper region of the product 20 are then formed by melting substantially identical predetermined regions 26 of successive powder layers in a generally conventional manner.

As will be appreciated, when the product 20 has been fully formed via the method described above, it may be removed from the EBM apparatus and from the powder bed 25, whereupon the support pins 22 can be removed during a subsequent finishing process. As indicated above, the support pins 22 have been found to be significantly easier, and less wasteful, to remove than prior art wafer structures.

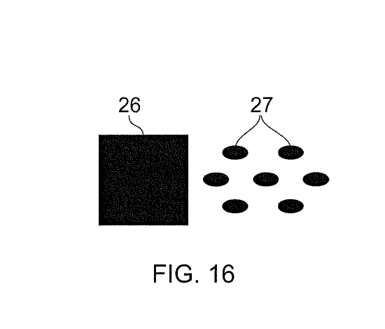

As will be appreciated, the invention has been described above with specific reference to an embodiment in which the support pins 22 are parallel to one another and are formed such that they extend substantially vertically within the powder bed. This is achieved by melting support areas 27 of successive layers which are substantially circular and which are arranged in alignment with one another, such that respective cross-sections of the pins 22 are built up vertically. However, FIGS. 15 and 16 illustrate an alternative method in which the pins 22 are formed so to extend non-vertically within the powder bed 25, such that the pins are non-parallel to the vertical working axis of the machine

FIG. 15 shows an inclined downwardly facing surface 21 b of a product, from which depend a plurality of parallel support pins 22. However, as can be seen immediately, the pins 22 make an acute angle to the vertical axis z rather than being oriented vertically as shown in FIG. 6. FIG. 16, which illustrates a similar view to FIG. 12 described above, shows how this achieved.

As will be noted from FIG. 16, in this embodiment, the support areas 27 of each powder layer are elliptical in shape, rather than circular as was the case in the embodiment described above and as shown in FIG. 12. Furthermore, as will be appreciated having regard to FIG. 15, the elliptical support areas 27 pertaining to each support pin are melted in successive powder layers in an imbricated manner, such that the successive horizontal cross-sections of each support pin are partially horizontally offset from one another. In this manner, the support pins 22 are built up so as to still be cylindrical in form, but so that they are non-vertical within the powder bed 25. This type of support structure can be very useful and offers increased flexibility over prior art wafer support structures.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. An additive layer manufacturing (ALM) method for the production of a three-dimensional product via successive fusion of parts of a powder bed, said parts corresponding to successive cross-sections of the product, the method comprising the steps of: a) laying down a powder layer on said powder bed, and b) focussing energy on a predetermined area of said powder layer to fuse said area of the powder layer and thereby form a cross-section of the product; wherein steps a) and b) are repeated to form successive cross-sections of the product, and wherein at least one of said steps b) involves focussing said energy on an area of the respective powder layer which is at least partially unsupported by a previously formed cross-section of the product to thereby form a downwardly facing surface of the product, the method being characterised in that at least some of said successive steps b) involve focussing energy on a support area of the respective powder layer, to fuse the support area and thereby form successive cross-sections of a support pin within the powder bed, the support pin extending outwardly from the downwardly facing surface of the product when it is formed, so as to support the downwardly facing surface.

2. An ALM method according to claim 1, wherein at least some of said successive steps in which energy is focussed on a support area of a respective powder layer also involve focussing energy on a said predetermined area of the powder layer to fuse said area of the powder layer and thereby form a cross-section of the product, the support area and the predetermined area being spaced apart.

3. An ALM method according to claim 1, wherein said support pin extends generally downwardly from said downwardly facing surface of the product.

4. An ALM method according to claim 1, wherein said successive steps in which energy is focussed on a support area of the respective powder layer involve focussing energy on a plurality of said support areas in spaced relation to one another, to thereby form successive cross-sections of a plurality of said support pins, the support pins being formed in a spaced array within the powder bed.

5. An ALM method according to claim 4, wherein said support pins are parallel to one another.

6. An ALM method according to claim 1, in which the or each support pin is cylindrical.

7. An ALM method according to claim 6, in which the or each support pin has a diameter in the range of 0.2 mm to 2 mm.

8. An ALM method according to claim 1, wherein the or each said support area is approximately circular, and energy is focussed on successive said support areas of respective powder layers which are in alignment to one another to form successive circular cross-sections of the or each support pin which is thus cylindrical.

9. An ALM method according to claim 8, in which the or each support pin is formed so as to extend vertically within the powder bed.

10. An ALM method according to claim 1, wherein the or each said support area is approximately elliptical, and energy is focussed on successive said support areas of respective powder layers which are imbricated to form successive elliptical cross-sections of the or each support pin which is thus cylindrical.

11. An ALM method according to claim 10, wherein the or each support pin is formed so as to extend non-vertically within the powder bed.

12. An ALM method according to claim 1, wherein the or each support pin has a free end which is formed within the powder bed.

13. An ALM method according to claim 1, wherein the free end of the or each said support pin is spaced from any other surface of the product, and is also spaced from any base plate used to support the powder bed.

14. An ALM method according to claim 12, wherein the free end of the or each said support pin is formed by focussing energy on an initial support area which is supported only by underlying unfused powder in the powder bed, to fuse said initial support area and thereby form the free end.

15. An ALM method according to claim 1, the method being used to manufacture a metal component, in which said powder is metal powder, and in which said steps of focussing energy on said areas of the powder layers involves the use of an electron beam to melt said areas of the powder layers.

16. The method according to claim 1 to manufacture a component of a gas turbine engine, involving the step of removing the or each said support pin from said product to form said component.
